(19) United States
(12) Patent Application Publication
(10) Pub. No.: US 2010/0314472 A1
(43) Pub. Date: Dec. 16, 2010

(54) Shower Nozzle

(76) Inventor: Chin-Tsai Lee, Hsien Hsi Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/485,208

(22) Filed: Jun. 16, 2009

(51) Int. Cl. B05B 1/14

(52) U.S. Cl. 239/553

(57) ABSTRACT

A shower nozzle comprises a base and a joint, wherein the base includes a cover and a watering plate, the cover includes a connecting hole formed at a central portion thereof, and the cover includes a plurality of watering apertures arranged thereon; the joint includes a screwing mount and a coupling member, the screwing mount includes a peripheral tab extending from a lower end of an outer rim thereof, an engaging bore fixed on a lower end of an inner wall thereof, and a fitting projection attached around an outer periphery of the engaging bore, and the coupling member includes a screw portion secured on an upper end of an outer periphery thereof, and includes a number of outlets disposed on a lower end of the outer periphery thereof.

### BACKGROUND OF THE INVENTION

1. Field of the Invention

The present invention relates to shower nozzle that can enhance structural strength and exterior appearance.

1. Description of the Prior

Conventional thin-type shower nozzle includes a watering plate and a cover, however, they are assembled together by using their peripheries, therefore the watering plate becomes deformable because of the impact of the water pressure, causing water leak and disengagement easily. Besides, the thickness of the water plate is limited that can not be produced in an ultra thin type.

To improve such a defect, an improved shower nozzle as shown in FIGS. 1 and 2 has been developed and includes a base 10 and a screwing mount 20, wherein the base 10 includes a cover 101 connected with a watering plate 102 so as to form a chamber 103 in an interior thereof, the cover 101 includes a connecting hole 1011 disposed on a central portion of a top surface thereof, and the watering plate 102 includes a plurality of watering apertures 1021 arranged thereon, the screwing mount 20 is fitted to the connecting hole 1011 of the cover 101, and includes a peripheral tab 201 arranged on a middle portion thereof, a through slot mounted on a lower end thereof, a plurality of watering recesses 202 fixed on an outer rim of the lower end thereof, such that the peripheral tab 201 contacts with the connecting hole 1011 of the cover 101 to weld the cover 101 and the screwing mount 20 together, and the outer rim of the lower end of the screwing mount 20 abuts against the watering plate 102 so as to be welded with the watering plate 102.

However, the cover 101 of the base 10 and the watering plate 102 have to be assembled together in advance, and then the screwing mount 20 is fitted to the connecting hole 1011 to be welded with the cover 101, therefore the cover 101 of the base 10 and the watering plate 102 will generate a flexible deformation after being welded, having fragile structure and poor appearance.

The present invention has arisen to mitigate and/or obviate the afore-described disadvantages.

### SUMMARY OF THE INVENTION

The primary object of the present invention is to provide a shower nozzle that can enhance structural strength and exterior appearance.

A shower nozzle in accordance with a preferred embodiment of the present invention comprises:

a base and a joint, wherein the base includes a cover and a watering plate, the cover includes a connecting hole formed at a central portion thereof, and the cover includes a plurality of watering apertures arranged thereon; wherein

the joint includes a screwing mount and a coupling member, the screwing mount includes a peripheral tab extending from a lower end of an outer rim thereof, an engaging bore fixed on a lower end of an inner wall thereof, and a fitting projection attached around an outer periphery of the engaging bore so as to be fitted to the connecting hole of the cover, such that the peripheral tab abuts against the connecting hole to be welded together with the connecting hole, the coupling member includes a screw portion secured on an upper end of an outer periphery thereof, and includes a number of outlets disposed on a lower end of the outer periphery thereof so that an end portion of the coupling member is biased against a central portion of the watering plate to be welded with the watering plate.

### BRIEF DESCRIPTION OF THE DRAWINGS

FIG. 1 is a perspective view showing the exploded components of a convention shower nozzle;

FIG. 2 is a cross sectional view showing the assembly of the convention shower nozzle;

FIG. 3 is a perspective view showing the exploded components of a shower nozzle according to a preferred embodiment of the present invention;

FIG. 4 is a perspective view showing the partial assembly of the shower nozzle according to the preferred embodiment of the present invention;

FIG. 5 is a perspective view showing the assembly of the shower nozzle according to the preferred embodiment of the present invention;

FIG. 6 is a cross sectional view showing the assembly of the shower nozzle according to the preferred embodiment of the present invention;

FIG. 7 is a cross sectional view showing the operation of the shower nozzle according to the preferred embodiment of the present invention.

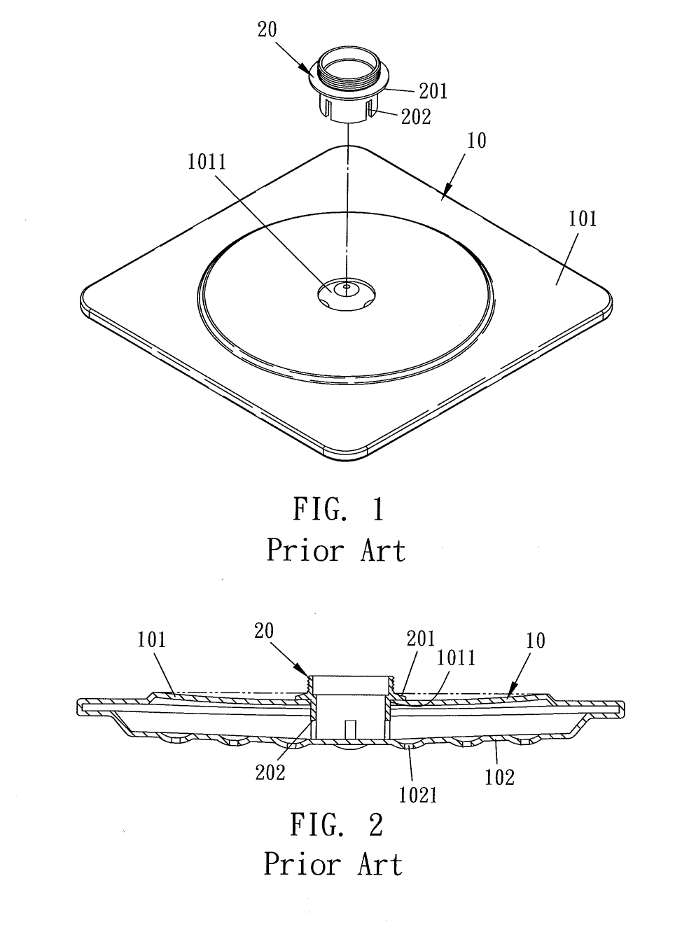

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

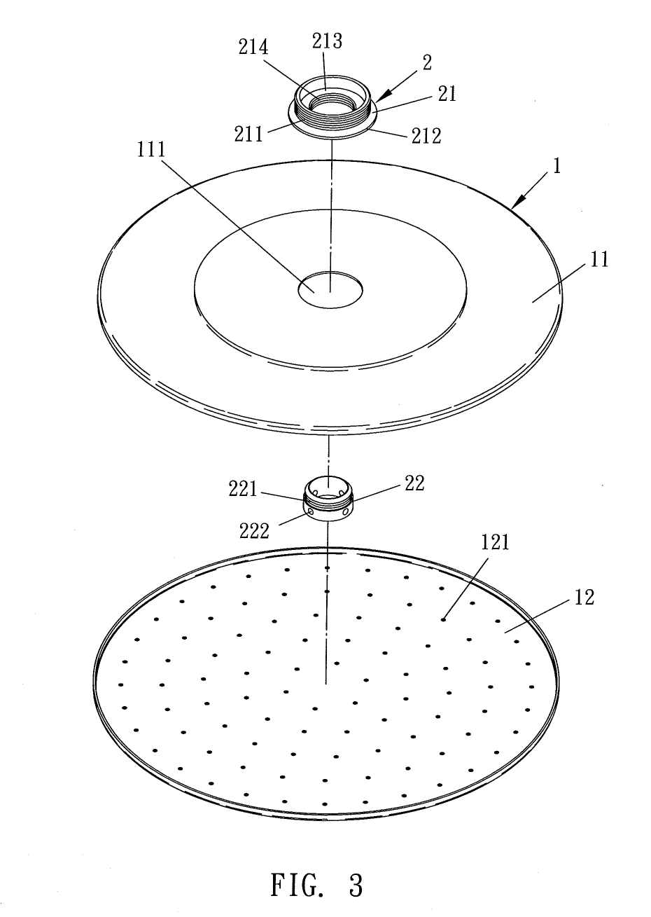

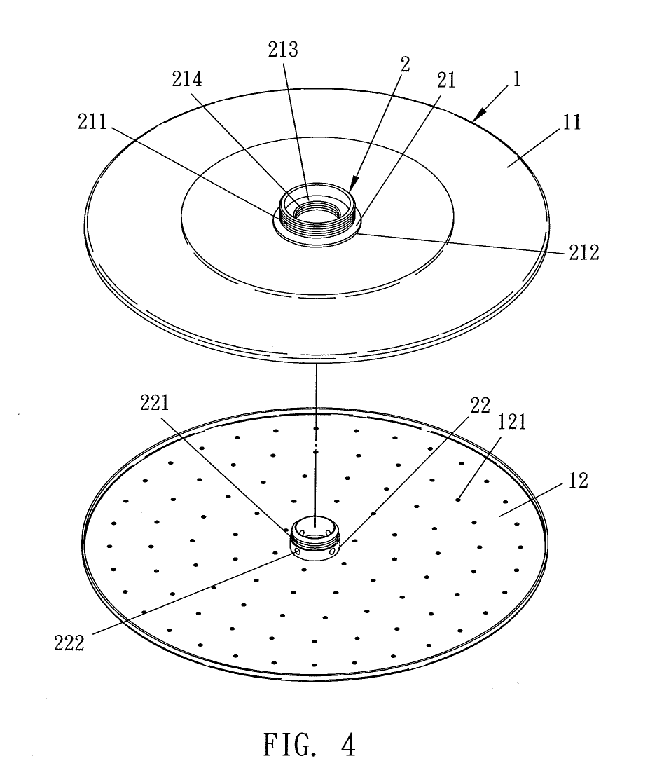

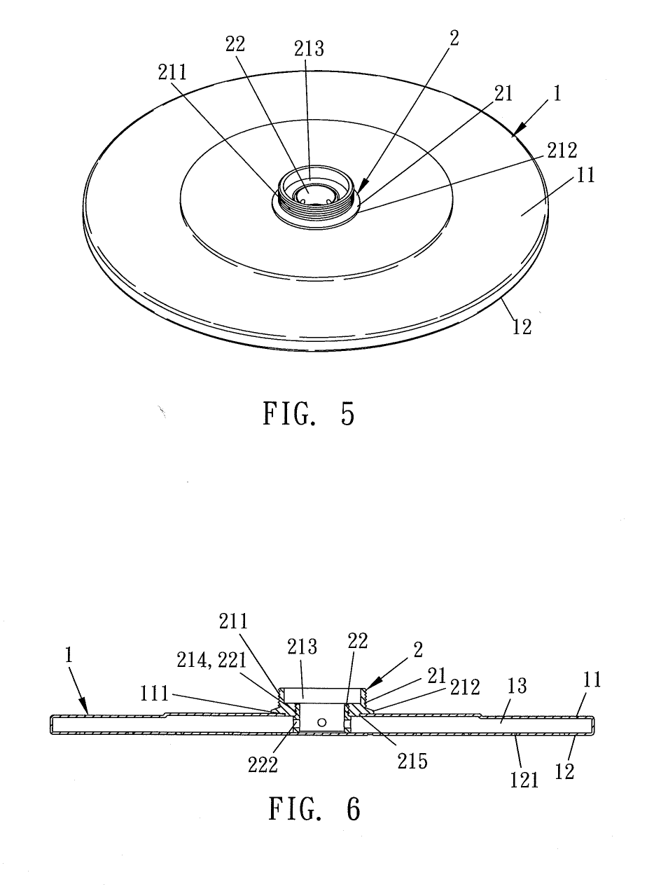

Referring to FIGS. 3-6, a shower nozzle according to a preferred embodiment of the present invention comprises: a base 1 and a joint 2, wherein the base 1 includes a cover 11 and a watering plate 12, the cover 11 includes a connecting hole 111 formed at a central portion thereof, and the cover 12 includes a plurality of watering apertures 121 arranged thereon, and the joint 2 includes a screwing mount 21 and a coupling member 22, the screwing mount 21 includes outer threads 211 formed around an outer rim thereof, a peripheral tab 212 extending from a lower end of the outer rim thereof, a cavity 213 formed on an exterior of an upper end thereof, an engaging bore 214 fixed on a lower end of an inner wall thereof, and a fitting projection 215 attached around an outer periphery of the engaging bore 214. The coupling member 22 is formed in a tube shape and includes a screw portion 221 secured on an upper end of an outer periphery thereof, and includes a number of outlets 222 disposed on a lower end of the outer periphery thereof.

In assembly, the fitting projection 215 of the screwing mount 21 is fitted to the connecting hole 111 of the cover 11 so that the peripheral tab 212 abuts against the connecting hole 111 to be welded together with the connecting hole 111, and an end portion of the coupling member 22 is biased against a central portion of the watering plate 12 to be welded with the watering plate 12, and the screw portion 221 of the coupling member 22 is screwed with inner threads of the engaging bore 214 so that the cover 11 and the watering plate 12 are welded together, such that a closed chamber 13 between the cover 11 and the watering plate 12 is formed.

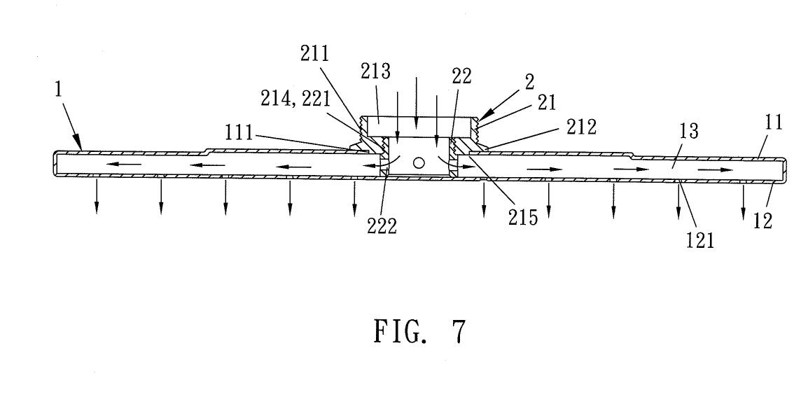

In operation, as shown in FIG. 7, because the screwing mount 21 of the joint 2 and the wall pipe are assembled together, when a tap is turned on, water flows from the wall pipe into the chamber 13 through the outlets 222 of the coupling member 22 of the base 1 and then sprinkles out of the watering apertures 121 of the watering plate 12.

Therefore, the cover 11 of the base 1 and the watering plate 12 are welded with the screwing mount 21 of the joint 2 and the coupling member 22 respectively and are screwed together by using the screwing mount 21 and the coupling member 22 so that the cover 11 and the watering plate 12 are welded together to form the closed chamber 13, such that a flexible deformation will not occur between the cover 11 and the watering plate 12, thereby enhancing structural strength and exterior appearance.

While we have shown and described various embodiments in accordance with the present invention, it is clear to those skilled in the art that further embodiments may be made without departing from the scope of the present invention.

What is claimed is:

1. A shower nozzle comprising:
a base and a joint, wherein the base includes a cover and a watering plate, the cover includes a connecting hole formed at a central portion thereof, and the cover includes a plurality of watering apertures arranged thereon; wherein
the joint includes a screwing mount and a coupling member, the screwing mount includes a peripheral tab extending from a lower end of an outer rim thereof, an engaging bore fixed on a lower end of an inner wall thereof, and a fitting projection attached around an outer periphery of the engaging bore so as to be fitted to the connecting hole of the cover, such that the peripheral tab abuts against the connecting hole to be welded together with the connecting hole, the coupling member includes a screw portion secured on an upper end of an outer periphery thereof, and includes a number of outlets disposed on a lower end of the outer periphery thereof so that an end portion of the coupling member is biased against a central portion of the watering plate to be welded with the watering plate.

2. The shower nozzle as claimed in claim 1, wherein the engaging bore of the screwing mount includes inner threads formed around an inner wall thereof, and the screwing mount includes outer threads formed around an outer rim thereof.

3. The shower nozzle as claimed in claim 1, wherein the coupling member is formed in a tube shape.

4. The shower nozzle as claimed in claim 1, wherein the cover and the watering plate are screwed together by using the screw portion of the coupling member and the engaging bore of the screwing mount and then welded as a whole.
